(19) United States
(12) Patent Application Publication
(10) Pub. No.: US 2010/0147409 A1
(43) Pub. Date: Jun. 17, 2010

(54) TECHNIQUE FOR REPAIRING, STRENGTHENING AND CRACK ARREST OF PIPE

(75) Inventors: Minxu Lu, Beijing (CN); Xiuyun Wang, Beijing (CN); Jinghong Ruan, Beijing (CN); Guo Liu, Beijing (CN); Jinyou Wang, Beijing (CN)

Correspondence Address: SHERIDAN ROSS PC, 1560 BROADWAY, SUITE 1200, DENVER, CO, 80202, US

(73) Assignee: BEIJING SAFETECH PIPELINE CO., LTD., Beijing (CN)

(21) Appl. No.: 12/522,820

(22) PCT Filed: Jan. 15, 2008
(86) PCT No.: PCT/CN08/00099

§ 371 Date: Jan. 4, 2010

(30) Foreign Application Priority Data
Jan. 15, 2007 (CN) 200710062720.0

(51) Int. Cl. F16L 55/168; B29C 73/04

(52) U.S. Cl. 138/99; 156/94; 138/149

(57) ABSTRACT

A method for repairing/strengthening and crack arrest of pipe, especially metal pipe, in which, first, to cover an insulated material on the position needing repairing/strengthening and crack arrest, then to lay a high strength fiber composite material. The modulus of elasticity of the material used in the invention is close to the metal pipe's, it can be integrated with the pipe and bear the internal pressure with the pipe, thus the final composite pipe reaches required bear capacity, such as, the original most operation pressure of pipe can be recovered; and it can take effect for crack arrest of pipes when pipes happen burst accident. Otherwise, because of the insulated material is used on the bottom layer, it prevent thoroughly from galvanic corrosion between pipe and strengthening material. The method can be implemented simply and without fire, it is advantageous to tight joint between strengthening material and pipe, and between strengthening layers, and it can be used to repair and enhance the pipeline in use.

### CROSS REFERENCE TO RELATED APPLICATIONS

This application is a national stage application under 35 U.S.C. 371 of PCT Application No. PCT/CN08/00099 having an international filing date of 15 Jan. 2008, which designated the United States, which PCT application claimed the benefit of Chinese Application No. 200710062720.0 filed 15 Jan. 2007, the entire disclosure of each of which are hereby incorporated herein by reference.

### FIELD OF THE INVENTION

The present invention relates to a technique for repairing, strengthening and/or crack arrest of pipes, especially metal pipes, by using insulated materials and fiber composite materials. More particularly, the present invention relates to a method for repairing, strengthening and/or crack arrest of pipes by combining insulated composite materials and high strength resin-based fiber composite materials, and the use of such a method in transport pipelines.

### BACKGROUND OF THE INVENTION

Oil and gas pipeline transportation is among the top five transportation industries of the national economy in China, and the length of long-distance gas and oil pipelines currently in China reaches even more than 50 kilometers. For the pipes in a long term service, accidents, for example pipe outburst and leakage, occur as a result of effects such as strata pressure, soil corrosion, galvanic corrosion and external injury to pipes; or the insufficiency of the existing transportation capacity or the designed capacity to meet the increasing demand for transport results in inability to raising the pressure as desired; or higher security is required as the natures of regions through which the pipes pass change. All of these aspects influence the normal transportation operation of pipes. Bursting and leakage accidents often happen to gas and oil pipelines over the world, for example, a gas pipeline explosion in Ural of the former Soviet Union in 1989 caused 1024 casualties; and a large accident in North America, 13 kilometers of pipelines cracking, occurred due to a gas pipeline explosion. A large number of on site survey shows that more than 60% of gas and oil pipelines in service in China come into an accident-prone period.

In general, when defective gas and oil transportation pipelines are in operation, transportation under a reduced pressure is often adopted; when existing conditions cannot satisfy the enhanced requirement on transportation or the change in the natures of regions through which pipes pass, the most employed solution is maintaining the existing pipes, and new pipes are established in the case that the existing pipes can not be used any longer. This not only affects the routine production and operation, but also greatly increases the operating costs. Therefore, there still exists a need in the art to develop a method for repairing and reinforcing pipes with good efficiency, high safety and easy implementation.

The existing techniques for repairing and strengthening defects outside the oil and gas pipelines mainly involve the conventional methods such as patching scars by welding and strengthening with composite materials. The risk of welding through and hydrogen induced embrittlement may be faced during the process of patching scars by welding, especially in the case of gas lines with non-stop transportation, and therefore this method is usually not recommended. Resin-based composite materials, due to their excellent characteristics such as light weight and high strength, corrosion resistance, good durability, easy construction, and no influence on the appearance of structures, have been used to repair pipeline by many oil and gas companies all over the world. For example the technique from Clockspring Company in the United States for repairing and strengthening pipelines with composite materials employs isophthalic acid-based unsaturated polyester and the E-glass fiber to combine into a composite sheet, which covers the surface of metal pipe by dry laying with epoxy adhesives binding between the layers. One drawback of this technique is incapacity to guarantee a close attachment between the composite sheet and pipe body and between the layers of composite sheets during the construction process; the other drawback results from the relatively low elastic modulus and strength of glass fiber, which leads to relatively thick reinforcement layers and therefore brings the subsequent anti-corrosion process difficult to be carried out and also limits the degree of enhancing the load capacity for substrate. Chinese Patent No. ZL200410080359.0 (University of Science and Technology in Beijing, China) discloses a technique for repairing and strengthening pipelines with carbon fiber composite materials. This technique has advantages such as high strength composite materials and thin reinforcing layers; however it still needs improvement due to the weakness such as relatively high costs and a certain possibility of galvanic corrosion and other factors.

In addition, catastrophic accidents caused by rupture of natural gas pipelines or long-distance crack propagation have occurred many times in history: an accident that cracks propagated up to 13 kilometers happened to the steel natural gas pipelines in U.S.; cracks up to 700 meters in length happened to a PE pipeline with a diameter of 315 mm in one country of Europe in 1986. Natural gas pipeline transportation started relatively late in China, and the pipe rolling, laying and management technology in the earlier stage was relatively poor. The history of natural gas transportation in China has been also accompanied with a lot of breakage accidents, for example, the pipeline ruptured in the pipeline portion spanning Juliu River from Tieling to Qinhuangdao during the pressure test; an explosion of the gas pipeline in Sichuan propagated due to hydrogen-induced cracking.

From the standpoint of the dynamic fracture mechanics, crack propagation in the pipeline is a fracture process with mutual coupling of high-pressure gas/fracture/components. Compared with the oil pipeline, cracks propagated more easily in the gas pipeline. This is because during the process of pipeline rupture and expansion, the natural gas has a decompression wave with such a low velocity that the crack tip may continue to maintain a high stress state and crack may continue to expand with a high speed as the velocity of the decompression wave of natural gas is lower than that of crack propagation in the pipeline.

At present, researchers have raised various models to predict the initiation and propagation of cracks in the pipes. The initiation of cracks in the pipes refers to a slow expansion of internal defects of the pipe within a certain limit. The first measurement to prevent cracks from propagating along the pipes is to improve the materials' performance from which the pipes are made and to decrease the internal defects in pipe materials. While in the case that cracks are present in the pipeline, the second measurement against the pipe accidents is to control the crack driving force to be less than the crack expansion resistance, so as to restrict the pipeline damage within a minimum extent as possible.

In addition to improving the crack propagation resistance of the pipeline by enhancing the materials' performance, anti-cracking components are frequently used in the practical projects to prevent and arrest the long-distance expansion of cracks in the pipelines. One type of the anti-cracking solution is to arrange the components in the form of thick steel rings axially on the external wall of the pipes at intervals; another type of the anti-cracking solution is to locally thicken the pipe wall along the pipe at intervals, so as to reduce the opening displacement of the pipe wall behind the cracks; the last type of the anti-cracking solution is to employ a wall material with higher toughness at the pipe cross-portion at intervals, these solutions are used so as to reduce the cracking driving force, or to increase the material fracture toughness of the local cross-portion, which will restrict the crack propagation along the pipeline and reduce the accident damage. Although these three solutions differs from each other, their principle is to locally increase anti-cracking capacity of the pipes and to restrict the damage within a certain extent, as shown in FIG. 1.

The above mentioned three types of anti-cracking solutions have some disadvantages during putting into usage. As to the type of applying the thick steel ring onto the external wall of the pipes, since the steel ring is of metal structure itself, has a large thickness, and clamps around the pipes. The protection of the pipes and these clamps is difficult and the corrosion may occur when the steel rings are used to clamp the pipes. Obviously, locally thickening the pipe wall and improving the mechanical properties of the pipe require higher skills in the pipe process, and the thickening of the pipe wall may disturb the subsequent pipeline-management. Moreover, none of the above three anti-cracking solutions is well suitable for PE pipeline, and they are also unsuitable for special-shaped pipeline.

So far there has been no report on the method of using several types of fibers, especially combining insulated materials with other high-strength fiber composite materials, to repair and strengthen pipelines, or on the method of applying the combination of insulated materials and high-strength fiber composite materials to arrest the pipe cracking.

The inventor combines insulated materials with other high-strength fiber composite materials to repair, strengthen and/or crack-arrest the pipelines, which produces an excellent effect and solves the problem unsolved in prior art for a long time.

Insulated fiber, one of the common insulated materials, includes glass fibers, basalt fibers, aramid fibers, ultrahigh molecular weight polyethylene fibers, and so forth, which can be produced in China now and show a good performance. High-strength insulated adhesive is currently common on the market as well, the high-strength insulated adhesive contact steel directly as reinforcement materials and are completely insulated, thus avoiding risks of the galvanic corrosion.

The inventor found that the technical solution of combining these two materials, i.e., covering the outer layer of insulating material with other high-strength fiber composite materials, is superior to the present repairing and strengthening technical solutions either in cost or in technical safety, thus achieving the present invention.

### SUMMARY OF THE INVENTION

The objective of the present invention is to provide a method for repairing, strengthening and/or crack-arresting pipes with composite materials, characterized in that covering an insulated material on the pipe's portions to be repaired, strengthened and/or crack-arrested, then laying a high strength fiber composite material. This method is easy to carry out with low cost, high safety and reliability.

In particular, the invention provides a method to repair, strengthen and/or crack-arrest pipes with composite materials, said method comprising the following steps:

(1) covering an insulated material on the portions of the pipe surface to be repaired, strengthened and/or crack-arrested,

(2) laying a high strength fiber composite material on the insulated material.

In the above mentioned method, the portions of the pipe surface to be repaired, strengthened and/or crack-arrested can be wholly covered; or the portions of the pipe surface to be repaired, strengthened and/or crack-arrested can be covered at two ends.

Herein, said insulated material can be any insulated material known in the art. Preferably, the insulated material used has a volume resistivity more than 109 Ω·m (according to “high-tech fibers”, Chemical Industry Press (China), page 144, the material with a volume resistivity more than 109 Ω·m is regarded as insulated), good electro-insulating and dielectric properties. Therefore, when insulated materials are used as the insulating layer of the pipe, the risk of galvanic corrosion and other chemical corrosions will be avoided.

The term “Fiber composite material,” as used herein, refers to the material with improved properties resulting from the combination of a certain fiber and other materials. Common fiber composite materials are those obtained by combining fibers with various resins and colloid with special properties to improve desired properties. For example, the fiber composite materials used in the present invention include the insulated fiber composite material with good insulating property and the fiber composite material with high strength.

The insulated materials used in the present invention include insulated resins with high strength, such as various adhesives without electro-conducting components, for example epoxy-based adhesives, phenolic resin-based adhesives.

The insulated materials can be any known high strength fiber composite material which is insulated, including insulated fiber composite materials such as glass fiber composite materials, basalt fiber composite materials, aramid fiber composite materials, and ultrahigh molecular weight polyethylene fiber composite materials.

Herein, said fiber can be continuous fibers selected from the group consisting of unidirectional fibers, orthogonal or diagonal non-weft fabric overlays, two-dimensional fabric laminates and multi-directionally woven fiber materials.

Herein, the glass fiber and basalt fiber are preferred for their high strength and good insulating property.

Among glass fibers, E glass fiber, S glass fiber and M glass fiber are preferably used for their good insulating property, high tensile strength, and strong corrosion resistance.

Basalt fiber, developed by the former Soviet Union, is an inorganic fiber produced by melting natural basalt ores as raw materials. And it has excellent characteristics such as high tensile strength, strong elastic modulus, good electro-insulating property, good corrosion resistance, and good chemical stability. Moreover, it can be used at a temperature of 600° C. or higher. It is superior to ordinary glass fibers in various performances. Since no boron or alkali metal oxides are emitted in the process of melting basalt, the manufacturing process of basalt fibers is unharmful to the environment which does not discharge industrial waste and emit harmful gas into the atmosphere, and thus basalt fiber is a new environmentally friendly fiber.

Basalt fiber can be produced in China now and its cost is much lower than carbon fiber. Basalt fiber has been applied in fiber-reinforced cement products, geotextile road grille, friction materials for automobile, and other fields. Therefore, Basalt fiber is preferred.

In the method according to the present invention, the most preferred insulated material is basalt fiber

In the method according to the present invention, the process of covering with the insulated composite material in the first step can be performed by wet laying, said wet laying comprising the following steps:

(1) applying a curable polymer onto the surface of pipe on which the insulated fiber material are to be laid;

(2) laying the insulated material and then roll pressing to allow the said insulated fibers uniformly impregnated with the curable polymer, which may be repeated several times;

repeating the steps (1) and (2) as required, then curing the curable polymer.

In the method according to the present invention, the process of covering with the insulated composite material in the first step can be performed by dry laying, said dry laying comprising the following steps:

(1) dip-coating the surface of the insulated fiber with a curable polymer to produce the insulated fiber prepreg;

(2) laying one or more layers of the insulated fiber prepreg formed from step (1) onto the surface of the pipe on which the insulated fiber material are to be laid, then curing.

Herein, the insulated fiber prepreg refers to a semi-finished product which is obtained by dip-coating the insulated fibers with a curable polymer and then carrying out certain treatment thereon. According to the methods for impregnating fibers with a curable polymer, the processes for producing prepregs are normally divided into: solution impregnation method, hot-melt impregnation, rubber film rolling method, and powder process method. It can be home-made, and also can be commercially available. Generally, most prepregs require storage at a low temperature, however some prepregs which can be stored at room temperature have been developed recently.

The quality of prepregs is very easy to control because the prepreg can be prepared in advance and the content of the curable polymer in the prepreg can be strictly controlled.

In the aforementioned two methods, each layer of the insulated fiber composite materials can be laid axially along the pipeline, surrounding the pipeline, or at a certain angle, or the combination thereof. The lap joints of the fiber in longitudinal and transversal directions should be kept for a certain length to ensure the construction quality.

In the aforementioned two methods, conventional methods can be used in the curing process. Vacuum curing is preferable in view of improving the curing quality.

In the aforementioned two methods, the said curable polymer includes base materials selected from the group consisting of thermosetting resins, thermoplastic resins and high-performance resins, with thermosetting resins preferred; and optionally auxiliary materials selected from the group consisting of curing agent, coupling agent, initiator, diluent, cross-linking agent, flame retardant, polymerization inhibitor, antistatic agent, light stabilizer, and filler.

Preferably, the said base material for a curable polymer is thermo-setting resin.

Said thermosetting resins can be the thermosetting resins known in the art, such as epoxy resins, phenolic resins, unsaturated polyester resins, polyurethane resins, polyimide resins, bismaleamide resins, silicone resins, allyl resins, and modified resins thereof.

Among them, epoxy resin is preferred due to its strong adhesion to various fibers, high mechanical properties, excellent dielectric property, and good chemical corrosion resistance.

The second step of the method according to the present invention is laying the fiber composite material onto the insulated material after covering with the insulated material.

Herein, the aforementioned process of laying the fiber composite material onto the insulated material involves dry-laying or wet-laying. The said wet-laying comprises the following steps:

(1) brushing a curable polymer to the surface of the insulated material;

(2) laying fibers and then roll pressing to allow the fibers uniformly impregnated with the curable polymer;

wherein steps (1) and (2) are repeated for several times as required, then curing.

Alternatively, the said dry-laying comprises the following steps:

(1) dip-coating a curable polymer onto the surface of the fiber to produce a fiber prepreg;

(2) laying one or more layers of the fiber prepreg from step (1), prior to curing;

Herein, the fiber prepreg refers to a semi-finished product which is obtained by certain treatment after dip-coating the fiber with a curable polymer. According to the process of impregnating fibers with a curable polymer, the methods for the production of prepregs are normally divided into the following catalogues: solution impregnation method, hot-melt impregnation method, rubber film rolling method, and powder method. It can be home-made, and also can be commercially available. Generally, most prepregs require storage at a low temperature; however some prepregs which can be stored at room temperature have been developed recently.

The quality of prepregs is very easy to control because the prepreg can be prepared in advance and the content of the curable polymer in the prepreg can be strictly controlled.

The curable polymer used in wet-laying or dry-laying of step 1 can also be used in step 2. In practice, the curable polymers used in step 1 and step 2 can be the same or different.

The fiber composite material includes glass fiber composite materials, basalt fiber composite materials, carbon fiber composite materials, aramid fiber composite materials, boron fiber composite materials and ultrahigh molecular weight polyethylene. Carbon fibers and basalt fibers are preferable due to their high strength and high modulus, and carbon fiber composite materials are more preferable.

Herein, the carbon fiber composite materials can be any carbon fiber composite material conventionally used in the art, for example, the fiber composite materials disclosed in the Chinese Patent No. ZL200410080359.0 (University of Science and Technology in Beijing, China) and the Chinese Patent Application No. 200510011581.X (Beijing Safetech Pipeline Co., Ltd.).

During repairing, strengthening and/or crack arrest of pipes with the aforementioned fiber composite materials, the layers of the fiber composite materials can be laid axially along the pipeline, surrounding the pipe, or at a certain angle, or the combination thereof.

The aforementioned fibers can be continuous fibers selected from the group consisting of unidirectional fibers, orthogonal or diagonal non-weft fabric overlays, two-dimensional fabric laminates and multi-directionally woven fiber materials.

In the aforementioned two methods, conventional techniques can be used in the curing process. Among these techniques, vacuum curing is preferable with a view to improving the curing quality.

In the aforementioned two methods, the said curable polymer includes base materials selected from the group consisting of thermosetting resins, thermoplastic resins and high-performance resins, with thermosetting resins preferred; and optionally auxiliary materials selected from the group consisting of curing agent, coupling agent, initiator, diluent, cross-linking agent, flame retardant, polymerization inhibitor, antistatic agent, light stabilizer, and filler.

Among them, the preferred base material for a curable polymer is thermosetting resin.

Said thermosetting resins can be the conventional thermosetting resins in the art, such as epoxy resins, phenolic resins, unsaturated polyester resins, polyurethane resins, polyimide resins, bismaleamide resins, silicone resins, ally resins, and modified resins thereof.

Among them, epoxy resin is preferred due to its strong adhesion to various fibers, high mechanical properties, excellent dielectric property, and good chemical corrosion resistance.

In particular, the method of repairing, strengthening and/or crack arrest of pipes with the composite materials according to the present invention comprises the following steps:

(1) covering an insulated material on the whole portion or at two ends of the portion of the pipe surface to be repaired, strengthened and/or crack-arrested by wet-laying or dry-laying; and

(2) laying a fiber composite material onto the insulated material.

Herein, the aforementioned process of laying the fiber composite material onto the insulated material involves dry-laying or wet-laying. The said wet-laying comprises the following steps:

(1) brushing a curable polymer to the surface of the insulated material;

(2) laying fibers and then roll pressing to allow the fibers uniformly impregnated with the curable polymer;

wherein the steps (1) and (2) are repeated for several times as required, then curing.

Alternatively, said dry-laying comprises the following steps:

(1) dip-coating a curable polymer onto the surface of the fiber to obtain a fiber prepreg;

(2) laying one or more layers of the fiber prepreg from step (1) prior to curing;

Herein, the fiber prepreg refers to a semi-finished product which is obtained by some treatment after dip-coating the fibers with a curable polymer. Based on the process of impregnating fibers with a curable polymer, the methods for the production of prepregs are normally divided into the following catalogues: solution impregnation method, hot-melt impregnation, rubber film rolling method, and powder method. It can be home-made, and also can be commercially available. Generally, most prepregs require storage at a low temperature; however some prepregs which can be stored at room temperature have been developed recently.

The quality of prepregs is very easy to control because the prepreg can be prepared in advance and the content of the curable polymer in the prepreg can be strictly controlled.

The curable polymer used in wet-laying or dry-laying of step 1 can be used in step 2. In practice, the curable polymers used in step 1 and step 2 can be the same or different.

More particularly, the method of repairing, strengthening and/or crack arrest of pipes with the composite materials according to the present invention comprises the following steps:

(1) covering an insulated material on the whole portion or at two ends of the portion of the pipe surface to be repaired, strengthened and/or crack-arrested by wet-laying or dry-laying, and curing the resultant insulated fiber layer;

(2) laying a fiber composite material outside the insulated materials obtained by wet-laying or dry-laying from step 1, and then curing the fiber composite materials.

With regard to wet laying or dry-laying, the same or different laying technique(s) can be employed in the above two steps.

In practice, both the step of laying the insulated fiber composite material by wet-laying or dry-laying and the step of laying the fiber composite on the insulated materials can be carried out on site.

When made on site, the dry-laying process is favorable under the circumstances where the pipelines on site are in a good condition, have no large uneven sites, and are not profiled pipeline accessories such as three-way joint, elbow, reducer, flange, and connector with small diameter. In this case, the operation on site is rather time-saving and will advantageously shorten the repair time.

When made on site, the wet-laying process shows excellent construction simplicity for the pipe body with uneven portions such as welding lumps and defects, or for the pipeline accessories such as three-way joint, elbow, reducer, flange, and connector with small diameter. During the operation, the curable polymer should be distributed as uniformly as possible, and allow high-strength fiber insulated materials fully impregnated therewith. During laying the fibers, the gas bubbles and porosity should be minimized, and means such as evacuation can be adopted if necessary.

In practice, the one skilled in the art can determine the layer number and the width of the fiber composite materials, and the amount of the repairing materials used from the particular conditions of pipelines according to his conventional defect-repairing parameters or pipeline-strengthening design approach. The lap joints of the fiber in longitudinal and transversal directions should be maintained for a certain length to ensure the construction quality.

In the aforementioned methods, each layer of the fiber composite materials can be laid axially along the pipeline, surrounding the pipeline, or at a certain angle, or the combination thereof. In practice, the skilled in the art can make a design in accordance with the particular conditions of pipelines.

In the aforementioned methods, the fiber can be continuous fibers selected from the group consisting of unidirectional fibers, orthogonal or diagonal non-weft fabric overlays, two-dimensional fabric laminates and multi-directionally woven fiber materials. In practice, the fiber can be chosen in accordance with the particular conditions of pipelines. Unidirectional fibers are normally used to simplify the design, while multi-directional fibers are sometimes used with a view of the construction simplicity and safety.

Prior to the repairing, strengthening and/or crack arrest of pipes, the pipeline optionally undergoes a surface treatment, for example, the treatment to improve the interface binding force, such as degreasing, rust-removing, phosphating, passivating, and coupling. Optionally, filling materials such as resins are used to fill up if uneven sites are present on the pipeline.

Upon the completion of repairing, strengthening and/or crack arrest of pipes according to the present invention, external anti-corrosion materials can be placed outside the high-strength fiber composite materials for anti-corrosion. Such anti-corrosion methods include spraying with polyurea or polyurethane, wrapping with polyethylene or polypropylene cold-wrapped adhesive tape, etc.

Based on various anti-corrosion materials, the anti-corrosive repair on the treated portions can be carried out after or before the adhesives on each adhesive surface in the repairing operation portions are apparently dried.

The portions to be repaired or strengthened according to the present invention comprise defective pipelines or pipeline accessories, as well as pipelines or pipeline accessories needing strengthening despite no defects; the portions to be crack-arrested comprise straight pipelines and pipeline accessories; wherein the pipeline accessories are, for example, three-way joint, elbow, reducer and flange.

Herein, said defects involve volume-type defects, plane-type (e.g., crack-type) defects, diffusive injury-type defects (e.g., hydrogen bubbles or micro-cracks), geometry-type defects (e.g., pout-like or displacement, etc.) such as defects in welding lines, and so on. Most common defects include volume-type defects, crack-type defects, hydrogen bubbles, micro-cracks, pout-like defects, and the displacement.

The method of repairing, strengthening and/or crack arrest of pipes according to the present invention can be used in metal pipes or non-metallic pipes, preferably metal pipelines, more preferably metals pipelines of oil or gas transportation in service.

If the process of excavation and backfilling is necessary, it should be carried out in compliance with the construction requirements to ensure construction quality. For example, for defect locations identified by on-site examination, the process of excavation must be manually performed under the inspection of on-site inspector. The measurement of burying depth must be noticed so as to prevent from the damage of anti-corrosion layers and steel pipes caused by ironware. After the repairing process is completed and no holidays are found at the excavated portions, the burying depth of the pipeline is ensured to meet the design requirements by tamping and backfilling in layers with fine sand or plain soil, and then cleaning the working field and restoring the original appearance of the terrain.

The method according to the present invention can satisfy simultaneously the needs of repairing, strengthening and/or crack arrest, or can be used to repair, strengthen or crack arrest separately.

Over the common methods used in the art where metals are employed for crack arrest, the crack arrest method according to the present invention has the following advantages:

The fiber composite materials have a lighter weight, causing no additional load on overhead pipelines or cross-over pipelines.

The fiber composite materials have a higher strength. For example, the tensile strength of a carbon fiber reaches 3500 MPa, which is about 10 times of the yield strength of a typical metallic material. A thinner layer of composite material can achieve the crack arrest effect of a thicker layer of metallic material.

The composite materials used in the present invention have a wide applicability due to their outstanding adhesion force for steel, PE pipes, etc.

Moreover, wrapping the insulated materials with the composite materials according to the present invention can also contribute to a favorable anti-corrosion effect to the pipes.

The composite materials according to the present invention exhibit a smaller thickness, thus facilitating anti-corrosion and thermal insulation for the pipes after winding the composite materials around the pipes.

The present invention further relates to a crack arrestor for pipes, comprising: insulated materials; and fiber composite materials laid on the insulated materials.

Preferably, the insulated materials include insulted resins or insulted fiber composite materials.

Preferably, the insulated fiber can be continuous fibers selected from the group consisting of unidirectional fibers, orthogonal or diagonal non-weft fabric overlays, two-dimensional fabric laminates, and multi-directionally woven fiber materials.

Preferably, the insulated fiber composite materials are selected from the group consisting of glass fiber composite materials, basalt fiber composite materials, aramid fiber composite materials, and ultrahigh molecular weight polyethylene fiber composite materials.

Preferably, the crack arrestor further comprises external layers of anti-corrosion materials placed outside the fiber composite materials to prevent from corrosion.

Preferably, the pipelines can be a metallic or non-metallic pipeline.

The crack arrestors comprising the composite materials according to the present invention can be formed on site. Therefore, their application is not limited to the straight pipes with regular geometry, and they can also be used in weld joints, the sizing heads, elbows, Y-pipe, T-pipe and other pipes or pipeline accessories with irregular geometries, as required.

The details of the materials and the methods according the invention are set forth in the following embodiments of the invention with reference to the accompanying drawings.

### DESCRIPTION OF DRAWINGS

FIG. 1 is a schematic diagram of the working principle of a crack arrestor, wherein 1 represents the gas flow flowing into the cracking area of the pipe, 2 represents the propagation of a crack, 3 represents the overflow of the gas from the opening, 4 represents a crack arrestor, 5 represents a pipeline, and 6 represents the transversal extension of the cracked pipe wall;

FIG. 2 is a schematic diagram of a pipeline after being repaired, wherein 7 represents a layer of carbon fiber composite materials, 8 represents a filling resin, and 9 represents a layer of basalt fiber composite materials;

FIG. 3 shows a test pipe, wherein 10 represents an outlet pipe, and 11 represents an inlet pipe;

FIG. 4 is a schematic diagram of defects, wherein 12 represents a defect;

FIG. 5 is a schematic diagram of a repaired pipeline, wherein 13 represents a layer of carbon fiber composite materials, 14 represents an epoxy sand slurry, and 15 represents an insulated epoxy structural adhesive;

FIG. 6 is a schematic diagram of a burst pipeline, wherein 16 represents an outlet pipe, 17 represents an inlet pipe, 18 represents a cracked site, and 19 represents a repaired site;

FIG. 7 is a schematic diagram of an elbow;

FIG. 8 is a schematic diagram of a repaired elbow.

### DETAILED DESCRIPTION OF EMBODIMENTS

The following examples are set forth to further illustrate the method and construction process of the invention. However, these examples are not intended to limit the scope of the present invention by any means.

### Example 1

### The Insulating Property of the Composite Material Layer Obtained by Placing the Insulated Materials as its Base Layer

The insulating property of the pipe after being repaired by the insulated material as the base layer was measured. A φ60 mm steel pipe was used and repaired according to the following steps:

1) cleaning up the portion of the pipe to be repaired, so as to remove the anti-corrosion layer, rust and other dirts, and achieve a surface treatment quality of level St3 as stipulated in GB/T8923-1988;

2) filling up the defects with epoxy sand slurry filling material;

3) brushing the surface of the pipe with phenolic resin adhesive 2130 after the filling material was apparently dried, and then surrounding the pipe with unidirectional basalt fibers with a width of 300 mm, and rolling press to allow the unidirectional basalt fibers uniformly impregnated with the curable polymer, thereby obtaining a total of 2 layers after repeating the step once more;

4) brushing the surface of basalt fibers with phenolic resin adhesive 2130, and then surrounding the pipe with orthogonal woven carbon fibers with a width of 300 mm, and rolling press to allow the carbon fibers uniformly impregnated with the curable polymer, thereby obtaining a total of 2 layers after repeating the step once more;

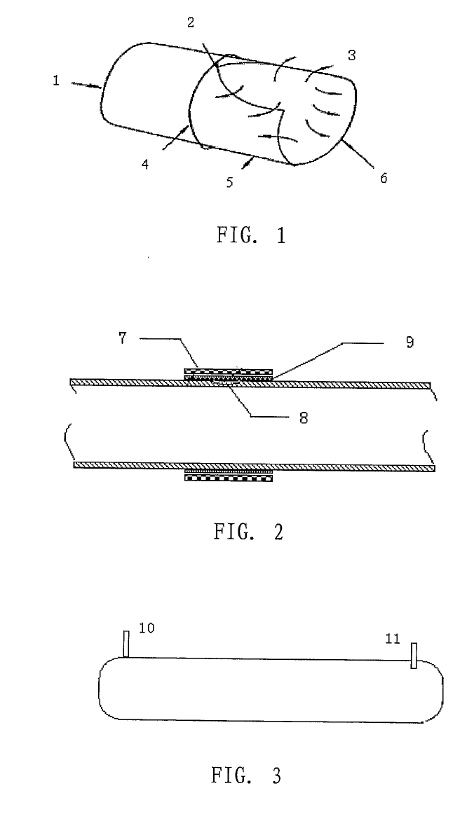

5) curing all the materials. The cross sectional view of the pipe thus repaired is shown in FIG. 2.

An electrospark leak detector was used to detect the repairing layer with a detection voltage of 10 kv, and no leak was found at all, indicating that the insulting property of the pipe after laying the insulated material thereon can sufficiently meet the application requirements.

### Example 2

### Evaluation of the Technical Solution According to the Invention with the Hydraulic Burst Test

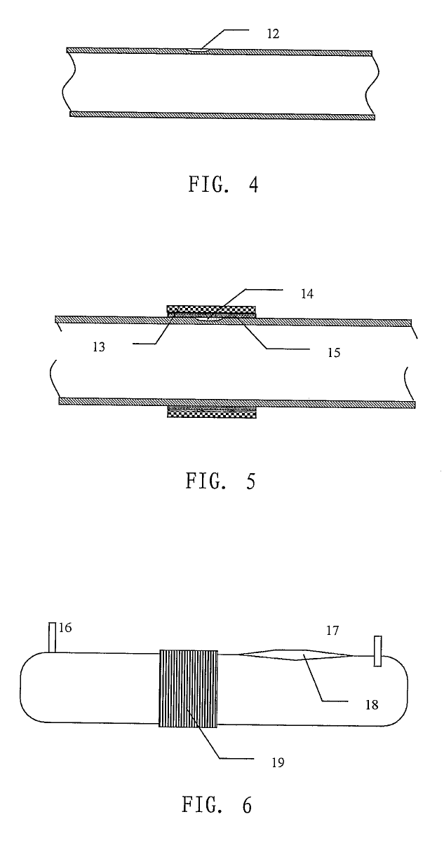

In order to examine the effect of the technical solution according to the present invention, the possible sizes of defects present in oil or gas transportation pipelines with a steel pipe φ273 as an example is stimulated by using the hydraulic burst test. The pipe to be tested is shown in FIG. 3, and the defects on the pipe are schematically shown in FIG. 4. The test was proceeding with the following steps:

1) cutting a 3 meter-long pipe from common pipelines for oil or gas transportation (the pipe was a spiral welded pipe Q235 with a diameter of 273 mm and a wall thickness of 7 mm), with both ends sealed with sealers having a vent and an inlet (see FIG. 3);

2) creating a defect with a size of 40 mm×13.5 mm×3.5 mm;

3) cleaning up the portion of the pipe to be repaired, so as to remove the anti-corrosion layer, rust and other dirts, and achieve a surface treatment quality of level St3 as stipulated in GB/T8923-1988;

4) filling up the defects with the filling material (epoxy sand slurry);

5) brushing the surface of the pipe with the epoxy structural adhesive (AK04-1 adhesive) after the filling material was apparently dried, and brushing the surface of the pipe with 191 phenolic resin adhesive after the surface was dried, and then surrounding the pipe with the unidirectional carbon fibers with a width of 300 mm, and rolling press to allow the carbon fibers uniformly impregnated with the 191 phenolic resin adhesive, thereby obtaining a total of 8 layers after repeating the step for several times, as shown in FIG. 5;

6) after the repairing layer was cured, injecting the water into the pipe to be tested to evacuate the air in the pipe, and after the pipe is full of the water, the pipe was examined to ensure no water leaking from the sample, then the pressure was increased stepwise until the sample was burst, as shown in FIG. 6.

The result of the burst test shows that the damage happened at the pipe body which had not been repaired, and appeared as a typical tear-type damage; the tested pipe exhibited an obvious expansion, and the defective portion which had been repaired and strengthened showed no noticeable change; the repaired pipe had a burst pressure of 16.7 Mpa, much higher than the designed operation pressure of the sample (6.4 Mpa), which indicates that the technique meet the purpose of the repair.

### Example 3

### Evaluation of the Technical Solution According to the Invention with Hydraulic Burst Test

Similar to example 1, the composite materials were used to repair the defects in the spiral welding lines, and then the repairing effect was examined with the hydraulic burst test.

The testing procedure was described as follows:

1) cutting a 3 meter-long pipe from common pipelines for oil or gas transportation (the pipe was a spiral welded pipe Q235 with a diameter of 325 mm and a wall thickness of 7 mm), with both ends sealed with sealers having a vent and an inlet;

2) creating a defect with a size of 60 mm×10 mm×5.16 mm at the spiral welding line of the pipe;

3) treating the portion of the pipe to be repaired with degreasing and rust-removal;

4) filling up the defects with epoxy filling resins;

5) laying two layers of aramid (1414) fiber prepreg (a prepreg made from aramid fibers and epoxy resins) with a width of 500 mm on the surface of the pipe after the filling material was dried, and then curing the layers by heating;

6) placing bidirectionally woven carbon fiber composite materials (with epoxy resin used as the matrix) on the surface of the aramid fiber composite materials by wet-laying in a total of 6 layers;

7) after the repairing layer was cured, injecting the water into the pipe to be tested to evacuate the air in the pipe, and after the pipe is full of the water, the pipe was examined to ensure no water leaking from the sample, then the pressure was increased stepwise until the sample was burst.

The result of the burst test shows that the damage happened at the pipe body which had not been repaired, and appeared as a typical tear-type damage; the tested pipe exhibited an obvious expansion, and the defective sites which had been repaired and strengthened showed no noticeable change; the repaired pipe had a burst pressure of 18.7 Mpa, much higher than the designed working pressure of the sample (6.4 Mpa), which indicates that the technique has already achieved the purpose of the repair.

### Example 4

### Applying the Technical Solution According to the Present Invention in Repairing an Elbow Pipe of a Metallic Pipeline

The composite materials according to the invention were used to repair and strengthen the elbow pipe to be pressurized.

The repair and strengthening process was described as follows:

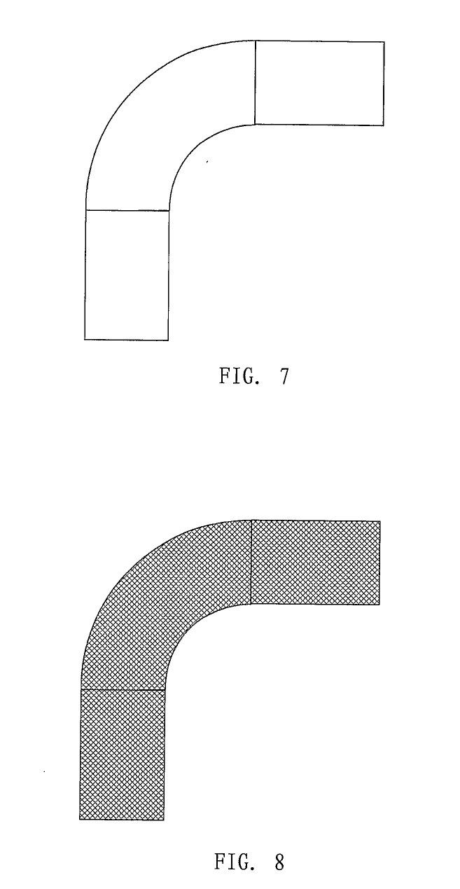

An elbow pipe of an oil transportation pipeline in a certain oil station is shown in FIG. 7. This pipe is a Q235 spiral welded pipe with a diameter of 529 mm, a wall thickness of 7 mm and a working pressure of 5.0 MPa. The purpose was to increase its operation pressure to 6.4 MPa.

The elbow was treated with degreasing and rust-removal.

The surface of the pipe was brushed with a curable polymer, PMR polyimide resin, and then 2 layers of bidirectionally cross-woven aramid fibers were laid around the pipe. After the resultant surface was apparently dried, it was brushed with an FMR polyimide resin, and then 2 layers of bidirectionally cross-woven carbon fibers were laid around the pipe, followed by rolling press. A total of 10 layers were obtained by repeating the step for several times. It is shown in FIG. 8.

A pressure test was performed on the pipe after curing of repairing layer. The pressure was increased to 8.9 MPa, and no abnormality was observed on the pipe body.

The test result shows that the repaired pipe body met the requirements under the testing pressure, which indicates that the technique has already achieved the purpose of the repair. The repaired pipe was completely qualified for operation under the pressure up to 6.4 MPa, that is to say, it met the requirements of pressurizing the pipe.

### Example 5

### Applying the Technical Solution According to the Present Invention in Repairing a Non-Metallic Pipeline

The sample is a process pipe from some oil station, and is made from PE pipeline with a diameter of 110 mm, a wall thickness of 10 mm and a working pressure of 0.8 MPa. The purpose was to increase its operation pressure to 1.2 MPa.

The pipe body was completely washed.

The surface of the pipe was brushed with the insulated epoxy resin adhesive (E-7), and then unidirectional glass fibers were laid around the pipes, followed by rolling press. A total of 10 layers were obtained by repeating the step for several times.

A pressure test was performed on the pipe after curing of repairing layer. The pressure was increased to 1.7 MPa, and the result indicates that the pipe body met the requirement of the pipe pressure and was acceptable, that is to say, the requirement of pressurizing the pipe was met.

### Example 6

### Applying the Technical Solution According to the Present Invention in Crack-Arresting a Pipeline

The specific process was proceeding as follows:

1) The sample is a long-distance gas pipeline, is made from x60 steel, has a diameter of 660 mm, a wall thickness of 7 mm, and a working pressure of 6.4 MPa.

2) The portion of the pipe to be attached with a crack arrestor was treated with degreasing and rust-removal.

3) The surface of the pipe was brushed with unsaturated polyester resin 191, and then a unidirectional glass fiber with a width of 300 mm was laid around the pipeline, followed by rolling press. A total of 2 layers were obtained by repeating the step once more.

4) After the surface was dried, it was brushed with unsaturated polyester resin 191, and then a unidirectional carbon fiber with a width of 300 mm was laid around the pipeline, followed by rolling press. A total of 8 layers were obtained by repeating the step for several times.

5) After all the materials were cured, a crack arrestor was formed on the gas pipeline. Dependent on the actual cases, more crack arrestors can be made according to the above procedure.

A number of embodiments of the invention have already been illustrated. It will be understood by the skilled in the art that many modifications and variances can be made to the invention without departing from the basic spirit of the invention, and all these modifications and variances are deemed as within the scope of the invention.

1. A method to repair, strengthen and/or crack-arrest pipes with composite materials, comprising the following steps:
(1) covering an insulated material on the portions of the pipe surface to be repaired, strengthened and/or crack-arrested; and
(2) laying a fiber composite material on the insulated material.

2. The method according to claim 1, wherein the portions of the pipe surface to be repaired, strengthened and/or crack-arrested is wholly covered by the insulated material.

3. The method according to claim 1, wherein the portions of the pipe surface to be repaired, strengthened and/or crack-arrested is covered at two ends thereof by the insulated material.

4. The method according to claim 1, wherein the insulated material comprise insulated resins or insulated composite materials.

5. The method according to claim 4, wherein the fibers are continuous fibers selected from the group consisted of unidirectional fibers, orthogonal or diagonal non-weft fabric overlays, two-dimensional fabric laminates, and multi-directionally woven fiber materials.

6. The method according to claim 4, wherein the insulated fiber composite materials are selected from glass fiber composite materials, basalt fiber composite materials, aramid fiber composite materials, and ultrahigh molecular weight polyethylene fiber composite materials.

7. The method according to claim 4, wherein wet-laying method is used to cover the insulated fiber composite materials, said wet laying method comprising the following steps:
(1) applying a layer of curable polymer onto the surface of pipe on which the insulated fiber material are to be laid;
(2) laying the insulated material and then roll pressing to allow the said insulated fibers uniformly impregnated with the curable polymer;
repeating the steps (1) and (2) as required, and then curing.

8. The method according to claim 4, wherein dry-laying method is used to cover the insulated fiber composite materials, said dry laying method comprising the following steps:
(1) dip-coating the surface of the insulated fiber with a curable polymer to produce the insulated fiber prepreg;
(2) laying one or more layers of the insulated fiber prepreg obtained from step (1) onto the surface of the pipeline where the insulated fiber material are to be laid, and then curing.

9. The method according to claim 7, wherein each layer of the insulated fiber composite materials can be laid axially along the pipeline, surrounding the pipe, or at a certain angle, or the combination thereof.

10. The method according to claim 7, wherein the said curable polymer includes base materials selected from the group consisting of thermosetting resins, thermoplastic resins and high-performance resins; and optionally auxiliary materials selected from the group consisting of curing agent, coupling agent, initiator, diluent, cross-linking agent, flame retardant, polymerization inhibitor, antistatic agent, light stabilizer, and filler.

11. The method according to claim 10, wherein the said base material for a curable polymer is thermo-setting resin.

12. The method according to claim 11, wherein the thermosetting resins are selected from the group consisted of epoxy resins, phenolic resins, unsaturated polyester resins, polyurethane resins, polyimide resins, bismaleamide resins, silicone resins, allyl resins, and modified resins thereof.

13. The method according to claim 1, wherein the process of laying the fiber composite material onto the insulated material involves dry-laying or wet-laying, the wet-laying comprising the following steps:
(1) brushing the curable polymer onto the surface of the insulated material;
(2) laying fibers and then roll pressing to allow the fibers uniformly impregnated with the curable polymer;
wherein steps (1) and (2) are repeated for several times as required, and then curing;
the dry-laying comprising the following steps:
(1) dip-coating a curable polymer onto the surface of the fiber to produce a fiber prepreg;
(2) laying one or more layers of the fiber prepreg from step (1), and then curing.

14. The method according to claim 13, wherein the fiber composite material is selected from the group consisted of glass fiber composite materials, basalt fiber composite materials, carbon fiber composite materials, aramid fiber composite materials, polyethylene with ultrahigh molecular weight, and boron fiber composite materials.

15. (canceled)

16. The method according to claim 13, wherein each layer of the fiber composite materials can be lain axially along the pipe, surrounding the pipe, or at a certain angle, or the combination thereof.

17. The method according to claim 13, wherein the curable polymer includes base materials selected from the group consisted of thermosetting resins, thermoplastic resins and high-performance resins; and optionally auxiliary materials selected from the group consisted of curing agent, coupling agent, initiator, diluent, cross-linking agent, flame retardant, polymerization inhibitor, antistatic agent, light stabilizer, and filler.

18. The method according to claim 17, wherein the base material for a curable polymer is thermo-setting resin.

19. The method according to claim 18, wherein the thermosetting resin is selected from the group consisted of epoxy resins, phenolic resins, unsaturated polyester resins, polyurethane resins, polyimide resins, bismaleamide resins, silicone resins, allyl resins, and modified resins thereof.

20. The method according to claim 1, further comprising optionally surface-treating the pipes prior to the repairing, strengthening and/or crack arrest of pipes, said surface treatment can be any treatment for improving the interface binding force, comprising degreasing, rust-removing, phosphating, coupling with coupling agents, and passivating.

21. The method according to claim 20, wherein the surface treatment further comprises filling up the geometry-irregular sites of the pipes with filling materials.

22. The method according to claim 1, further comprising applying external anti-corrosion materials on the fiber composite materials for anti-corrosion, after the completion of the repairing, strengthening and/or crack arrest of the pipes according to claim 1.

23. The method according to claim 1, wherein said portions to be repaired and strengthened comprise defective pipes or pipe accessories, as well as the pipes or the pipe accessories having no defects therein but need to be strengthened.

24. The method according to claim 1, wherein the s arrest comprise straight pipes and pipe accessories.

25. The method according to claim 23, wherein the pipe accessories comprise three-way joint, elbow, reducer, and flange.

26. The method according to claim 23, wherein the defects comprise volume-type defects, plane-type (crack-type) defects, diffusive injury-type defects (hydrogen bubbles, micro-cracks), and geometry-type defects (pout-like defects, displacement).

27. The method according to claim 26, wherein the defects include volume-type defects, crack-type defects, hydrogen bubbles, micro-cracks, pout-like defects, and the displacement.

28. The method according to claim 1, wherein the pipe can be metallic pipe or non-metallic pipe.

29. A crack arrestor for pipes, comprising:
insulated materials; and
fiber composite materials laid on the insulated materials.

30. The crack arrestor according to claim 29, wherein the insulated materials comprise insulated resins and insulated fiber composite materials.

31. (canceled)

32. The crack arrestor according to claim 30, wherein the insulated fiber composite materials are selected from the group consisted of glass fiber composite materials, basalt fiber composite materials, aramid fiber composite materials, and ultrahigh molecular weight polyethylene fiber composite materials.

33. The crack arrestor according to claim 29, further comprising external anti-corrosion materials applied outside the fiber composite materials for anti-corrosion.

34. The crack arrestor according to claim 29, the pipe can be metallic pipe or non-metallic pipe.

35. The method according to claim 8, wherein each layer of the insulated fiber composite materials can be laid axially along the pipeline, surrounding the pipe, or at a certain angle, or the combination thereof.

36. The method according to claim 14, wherein the fibers are continuous fibers selected from the group consisted of unidirectional fibers, orthogonal or diagonal non-weft fabric overlays, two-dimensional fabric laminates, and multi-directionally woven fiber materials.

37. The crack arrestor according to claim 30, wherein the fibers are continuous fibers selected from the group consisted of unidirectional fibers, orthogonal or diagonal non-weft fabric overlays, two-dimensional fabric laminates, and multi-directionally woven fiber materials.
